(19) United States
(12) Patent Application Publication
(10) Pub. No.: US 2025/0081217 A1
(43) Pub. Date: Mar. 6, 2025

(54) METHOD AND APPARATUS FOR NOTIFICATION MESSAGE TRANSMISSION IN A WIRELESS COMMUNICATION SYSTEM

(71) Applicant: ASUS Technology Licensing Inc., Taipei City (TW)

(72) Inventors: Li-Te Pan, Taipei City (TW); Richard Lee-Chee Kuo, Taipei City (TW)

(21) Appl. No.: 18/821,641

(22) Filed: Aug. 30, 2024

Related U.S. Application Data
(60) Provisional application No. 63/536,657, filed on Sep. 5, 2023.

(51) Int. Cl. H04W 72/40; H04W 88/04

(52) U.S. Cl. CPC H04W 72/40; H04W 88/04

(57) ABSTRACT

A method and device for notification message transmission. In one embodiment, a UE-to-UE (U2U) relay UE establishes a first PC5 Radio Resource Control (RRC) connection with a first remote UE and establishes one or more second PC5 RRC connections with one or more additional remote UEs so that the first remote UE can communicate with the one or more additional remote UEs via the U2U relay UE. The U2U relay UE also transmits a notification message to the first remote UE, wherein the notification message includes a sidelink indication type and information identifying a second remote UE among the one or more additional remote UEs.

### CROSS-REFERENCE TO RELATED APPLICATIONS

The present Application claims the benefit of U.S. Provisional Patent Application Ser. No. 63/536,657 filed on Sep. 5, 2023, the entire disclosure of which is incorporated herein in its entirety by reference.

### FIELD

This disclosure generally relates to wireless communication networks, and more particularly, to a method and apparatus for notification message transmission in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for notification message transmission. In one embodiment, a UE-to-UE (U2U) relay UE establishes a first PC5 Radio Resource Control (RRC) connection with a first remote UE and establishes one or more second PC5 RRC connections with one or more additional remote UEs so that the first remote UE can communicate with the one or more additional remote UEs via the U2U relay UE. The U2U relay UE also transmits a notification message to the first remote UE, wherein the notification message includes a sidelink indication type and information identifying a second remote UE among the one or more additional remote UEs.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 4.2.7.1-1 of 3GPP TS 23.304 V18.2.0. FIG. 4.2.8-1 of 3GPP TS 23.304 V18.2.0.

FIG. 6 is a reproduction of FIG. 4.2.7.2-1 of 3GPP TS 23.304 V18.2.0. FIG. 6.4.3.1-1 of 3GPP TS 23.304 V18.2.0.

FIG. 7 is a reproduction of FIG. 6.3.2.1-1 of 3GPP TS 23.304 V18.2.0. FIG. 6.7.1.1-1 of 3GPP TS 23.304 V18.2.0.

FIG. 8 is a reproduction of FIG. 6.3.2.1-2 of 3GPP TS 23.304 V18.2.0. FIG. 16.12.2.x-1 of 3GPP R2-2307920.

FIG. 9 is a reproduction of FIG. 6.3.2.3.2-1 of 3GPP TS 23.304 V18.2.0. FIG. 16.12.2.x-2 of 3GPP R2-2307920.

FIG. 10 is a reproduction of FIG. 6.3.2.3.3-1 of 3GPP TS 23.304 V18.2.0. FIG. 16.12.3.1 of 3GPP R2-2307920.

FIG. 11 is a reproduction of FIG. 6.5.1.1-1 of 3GPP TS 23.304 V18.2.0. FIG. 5.8.9.8.1-1 of 3GPP R2-2309185.

FIG. 12 illustrates an example of notification message transmission for single hop U2U Relay according to one exemplary embodiment.

FIG. 13 is a flow chart according to one exemplary embodiment.

FIG. 14 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 23.304 V18.2.0, “Proximity based Services (ProSe) in the 5G System (5GS) (Release 18)”; R2-2307920, “Introduction of NR sidelink relay enhancements”, LG Electronics; and R2-2309185, “Introduction of NR sidelink U2U relay”. The standards and documents listed above are hereby expressly incorporated by reference in their entirety.

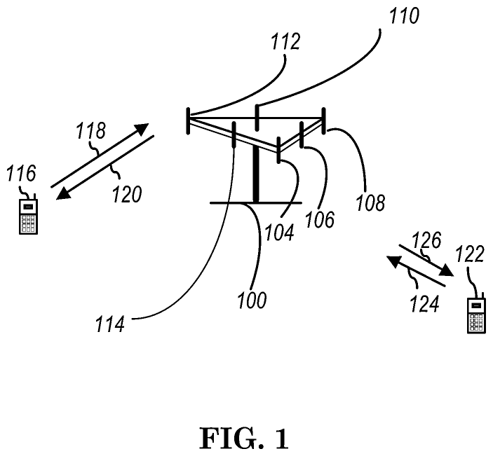

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

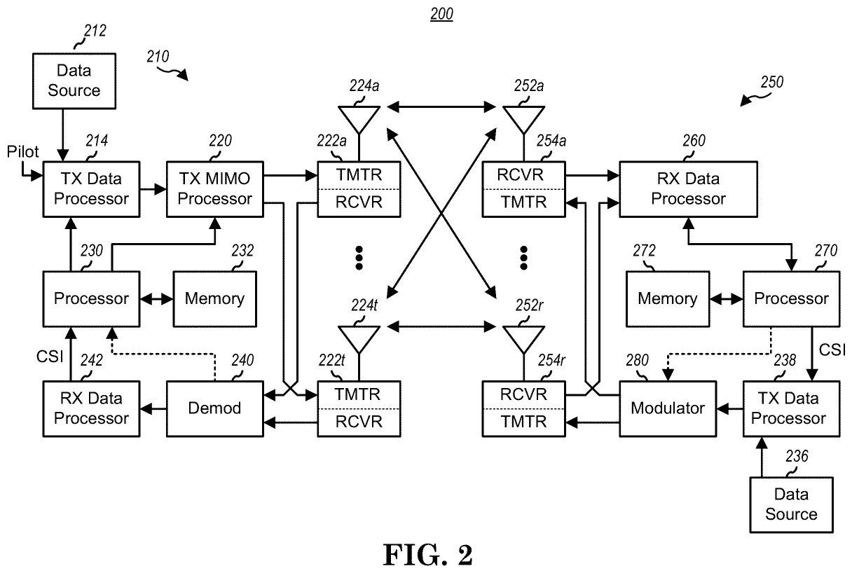

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

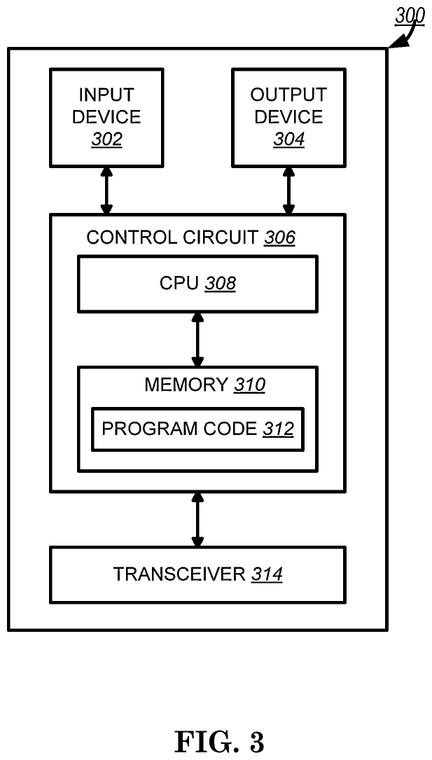

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

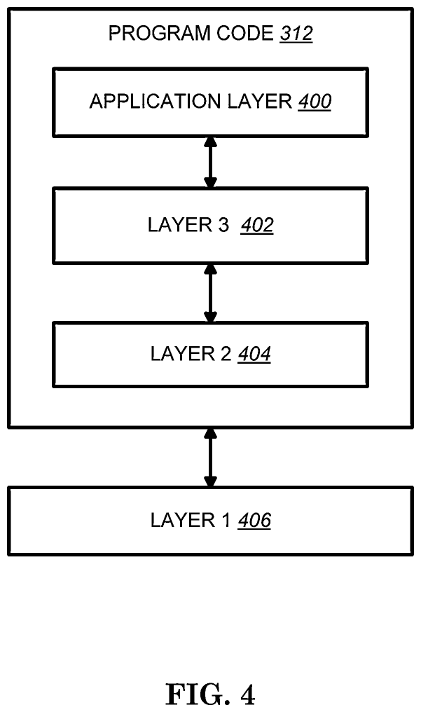

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 23.304 specifies procedures related to UE-to-UE Relay as follows:

### 4.2.8 5G ProSe UE-to-UE Relay Reference Architecture

FIG. 4.2.8-1 shows the Layer-2 and Layer-3 5G ProSe UE-to-UE Relay reference architecture. The 5G ProSe End UEs communicate with each other via a 5G ProSe UE-to-UE Relay.

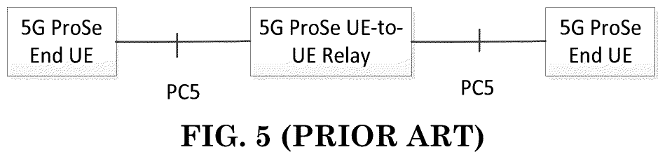

### [FIG. 4.2.8-1 of 3GPP TS 23.304 V18.2.0, Entitled “Reference Architecture for 5G ProSe UE-to-UE Relay”, is Reproduced as FIG. 5]

Each 5G ProSe End UE and the 5G ProSe UE-to-UE Relay may have subscriptions from the same PLMN or different PLMNs.

### 6.4.3.1 Layer-2 Link Establishment Over PC5 Reference Point

To perform unicast mode of ProSe Direct communication over PC5 reference point, the UE is configured with the related information as described in clause 5.1.3.

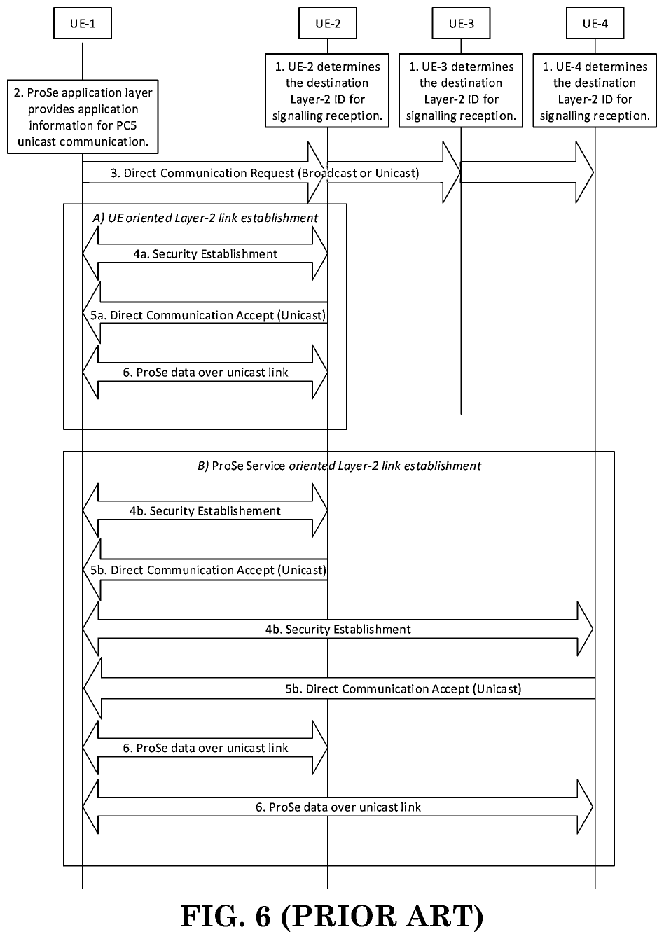

FIG. 6.4.3.1-1 shows the layer-2 link establishment procedure for the unicast mode of ProSe Direct communication over PC5 reference point.

### [FIG. 6.4.3.1-1 of 3GPP TS 23.304 V18.2.0, Entitled “Layer-2 Link Establishment Procedure”, is Reproduced as FIG. 6]

1. The UE(s) determine the destination Layer-2 ID for signalling reception for PC5 unicast link establishment as specified in clause 5.8.2.4.
2. The ProSe application layer in UE-1 provides application information for PC5 unicast communication. The application information includes the ProSe Service Info, UE's Application Layer ID. The target UE's Application Layer ID may be included in the application information.
   The ProSe application layer in UE-1 may provide ProSe Application Requirements for this unicast communication. UE-1 determines the PC5 QoS parameters and PFI as specified in clause 5.6.1.
   If UE-1 decides to reuse the existing PC5 unicast link as specified in clause 5.3.4, the UE triggers the Layer-2 link modification procedure as specified in clause 6.4.3.4.
3. UE-1 sends a Direct Communication Request message to initiate the unicast layer-2 link establishment procedure. The Direct Communication Request message includes:
   Source User Info: the initiating UE's Application Layer ID (i.e. UE-1's Application Layer ID).
   If the ProSe application layer provided the target UE's Application Layer ID in step 2, the following information is included:
      Target User Info: the target UE's Application Layer ID (i.e. UE-2's Application Layer ID).
   ProSe Service Info: the information about the ProSe identifier(s) requesting Layer-2 link establishment.
   Security Information: the information for the establishment of security.
NOTE 1: The Security Information and the necessary protection of the Source User Info and Target User Info are defined by SA WG3.
   The source Layer-2 ID and destination Layer-2 ID used to send the Direct Communication Request message are determined as specified in clauses 5.8.2.1 and 5.8.2.4. The destination Layer-2 ID may be broadcast or unicast Layer-2 ID. When unicast Layer-2 ID is used, the Target User Info shall be included in the Direct Communication Request message.
   UE-1 sends the Direct Communication Request message via PC5 broadcast or unicast using the source Layer-2 ID and the destination Layer-2 ID.
   A default PC5 DRX configuration may be used for transmitting and receiving of this message (see TS 38.300 [12]).
4. Security with UE-1 is established as below:
   4a. If the Target User Info is included in the Direct Communication Request message, the target UE, i.e. UE-2, responds by establishing the security with UE-1.
   4b. If the Target User Info is not included in the Direct Communication Request message, the UEs that are interested in using the announced ProSe Service(s) over a PC5 unicast link with UE-1 responds by establishing the security with UE-1.
NOTE 2: The signalling for the Security Procedure is defined by SA WG3.
   When the security protection is enabled, UE-1 sends the following information to the target UE:
      If IP communication is used:
         IP Address Configuration: For IP communication, IP address configuration is required for this link and indicates one of the following values:
         “DHCPv4 server” if only IPv4 address allocation mechanism is supported by the initiating UE, i.e., acting as a DHCPv4 server; or
         “IPv6 Router” if only IPV6 address allocation mechanism is supported by the initiating UE, i.e., acting as an IPV6 Router; or
         “DHCPv4 server & IPv6 Router” if both IPv4 and IPv6 address allocation mechanism are supported by the initiating UE; or
         “address allocation not supported” if neither IPv4 nor IPv6 address allocation mechanism is supported by the initiating UE.
         Link-Local IPv6 Address: a link-local IPv6 address formed locally based on RFC 4862 if UE-1 does not support the IPV6 IP address allocation mechanism, i.e. the IP Address Configuration indicates “address allocation not supported”.
      QoS Info: the information about PC5 QoS Flow(s). For each PC5 QoS Flow, the PFI and the corresponding PC5 QOS parameters (i.e. PQI and conditionally other parameters such as MFBR/GFBR, etc.) and optionally the associated ProSe identifier(s).
      Optional PC5 QoS Rule(s).
   The source Layer-2 ID used for the security establishment procedure is determined as specified in clauses 5.8.2.1 and 5.8.2.4. The destination Layer-2 ID is set to the source Layer-2 ID of the received Direct Communication Request message.
   Upon receiving the security establishment procedure messages, UE-1 obtains the peer UE's Layer-2 ID for future communication, for signalling and data traffic for this unicast link.
5. A Direct Communication Accept message is sent to UE-1 by the target UE(s) that has successfully established security with UE-1:
   5a. (UE oriented Layer-2 link establishment) If the Target User Info is included in the Direct Communication Request message, the target UE, i.e. UE-2 responds with a Direct Communication Accept message if the Application Layer ID for UE-2 matches.
   5b. (ProSe Service oriented Layer-2 link establishment) If the Target User Info is not included in the Direct Communication Request message, the UEs that are interested in using the announced ProSe Service(s) respond to the request by sending a Direct Communication Accept message (UE-2 and UE-4 in FIG. 6.4.3.1-1).
   The Direct Communication Accept message includes:
      Source User Info: Application Layer ID of the UE sending the Direct Communication Accept message.
      QoS Info: the information about PC5 QoS Flow(s). For each PC5 QoS Flow, the PFI and the corresponding PC5 QOS parameters requested by UE-1 (i.e. PQI and conditionally other parameters such as MFBR/GFBR, etc.) and optionally the associated ProSe identifiers(s).
      Optional PC5 QoS Rule(s).
      If IP communication is used:
         IP Address Configuration: For IP communication, IP address configuration is required for this link and indicates one of the following values:
         “DHCPv4 server” if only IPv4 address allocation mechanism is supported by the target UE, i.e., acting as a DHCPv4 server; or
         “IPv6 Router” if only IPv6 address allocation mechanism is supported by the target UE, i.e., acting as an IPV6 Router; or
         “DHCPv4 server & IPV6 Router” if both IPv4 and IPV6 address allocation mechanism are supported by the target UE; or
         “address allocation not supported” if neither IPv4 nor IPV6 address allocation mechanism is supported by the target UE.
         Link-Local IPV6 Address: a link-local IPv6 address formed locally based on RFC 4862 if the target UE does not support the IPV6 IP address allocation mechanism, i.e. the IP Address Configuration indicates “address allocation not supported”, and UE-1 included a link-local IPV6 address in the Direct Communication Request message. The target UE shall include a non-conflicting link-local IPv6 address.
   If both UEs (i.e. the initiating UE and the target UE) are selected to use link-local IPV6 address, they shall disable the duplicate address detection defined in RFC 4862 [17].
NOTE 3: When either the initiating UE or the target UE indicates the support of IPV6 routing, the corresponding address configuration procedure would be carried out after the establishment of the layer 2 link, and the link-local IPV6 addresses are ignored.
   The ProSe layer of the UE that established PC5 unicast link passes the PC5 Link Identifier assigned for the unicast link and the PC5 unicast link related information down to the AS layer. The PC5 unicast link related information includes Layer-2 ID information (i.e. source Layer-2 ID and destination Layer-2 ID). This enables the AS layer to maintain the PC5 Link Identifier together with the PC5 unicast link related information.
   Two UEs may negotiate the PC5 DRX configuration in the AS layer, and the PC5 DRX parameter values can be configured per pair of source and destination Layer-2 IDs in the AS layer.
6. ProSe data is transmitted over the established unicast link as below:
   The PC5 Link Identifier and PFI are provided to the AS layer, together with the ProSe data. Optionally in addition, the Layer-2 ID information (i.e. source Layer-2 ID and destination Layer-2 ID) is provided to the AS layer.
NOTE 4: It is up to UE implementation to provide the Layer-2 ID information to the AS layer. UE-1 sends the ProSe data using the source Layer-2 ID (i.e. UE-1's Layer-2 ID for this unicast link) and the destination Layer-2 ID (i.e. the peer UE's Layer-2 ID for this unicast link).
NOTE 5: PC5 unicast link is bi-directional, therefore the peer UE of UE-1 can send the ProSe data to UE-1 over the unicast link with UE-1.

### 6.4.3.7 Layer-2 Link Management Over PC5 Reference Point for 5G ProSe UE-to-UE Relay

### 6.4.3.7.1 Common Part for Layer-2 Link Management Over PC5 Reference Point for 5G ProSe UE-to-UE Relay

For the 5G ProSe Communication via 5G ProSe UE-to-UE Relay as described in clause 6.7.1 and clause 6.7.2:
The Direct Communication Request message over the first hop PC5 reference point includes:
   User Info ID of source 5G ProSe End UE: the identity of the source 5G ProSe End UE requesting relay operation (i.e. User Info ID).
   User Info ID of 5G ProSe UE-to-UE Relay: the identity of the UE-to-UE Relay provided to the source 5G ProSe End UE during 5G ProSe UE-to-UE Relay Discovery procedure (i.e. User Info ID).
   User Info ID of target 5G ProSe End UE: the identity of the target 5G ProSe End UE provided to the source 5G ProSe End UE during UE-to-UE Relay Discovery procedure (i.e. User Info ID).
   (optional) Destination Layer-2 ID of target 5G ProSe End UE: the unicast destination Layer-2 ID of the target 5G ProSe End UE determined by the source 5G ProSe End UE as specified in clause 5.8.2.4.
   ProSe Service Info: the information about the ProSe identifier(s) requesting Layer-2 link establishment.
   RSC: the connectivity service provided by the 5G ProSe UE-to-UE Relay as requested by the source 5G ProSe End UE.
   Security Information: the information for the establishment of security for the first hop PC5 link establishment.
NOTE 1: The Security Information is defined by SA WG3.

The Direct Communication Request message over the second hop PC5 reference point includes:
User Info ID of source 5G ProSe End UE.
User Info ID of target 5G ProSe End UE.
User Info ID of 5G ProSe UE-to-UE Relay.
ProSe Service Info: the information about the ProSe identifier(s).
RSC: the connectivity service provided by the 5G ProSe UE-to-UE Relay as requested by the source 5G ProSe End UE.
Security Information: the information for the establishment of security for the second hop PC5 link establishment.
NOTE 2: The Security Information is defined by SA WG3.

The Direct Communication Accept message over the second hop PC5 reference point includes:
User Info ID of target 5G ProSe End UE.

The Direct Communication Accept message over the first hop PC5 reference point includes:
User Info ID of target 5G ProSe End UE.
User Info ID of 5G ProSe UE-to-UE Relay.

The Link Modification Request message over the first hop PC5 reference point includes:
User Info ID of target 5G ProSe End UE: the identity of the target 5G ProSe End UE provided to the source 5G ProSe End UE during UE-to-UE Relay Discovery procedure.
(optional) Destination Layer-2 ID of target 5G ProSe End UE: the unicast destination Layer-2 ID of the target 5G ProSe End UE determined by the source 5G ProSe End UE as specified in clause 5.8.2.4.

The Link Modification Request message over the second hop PC5 reference point includes:
User Info ID of source 5G ProSe End UE.
User Info ID of target 5G ProSe End UE.

The Link Modification Accept message over the second hop PC5 reference point includes:
User Info ID of target 5G ProSe End UE.

The Link Modification Accept message over the first hop PC5 reference point includes:
User Info ID of target 5G ProSe End UE.

### 6.4.3.7.2 Layer-2 Link Management Over PC5 Reference Point for 5G ProSe Layer-2 UE-to-UE Relay

For the 5G ProSe Communication via 5G ProSe Layer-2 UE-to-UE Relay as described in clause 6.7.2, the description in clause 6.4.3.7.1 applies.

The message contents over PC5 reference point for unicast mode 5G ProSe Direct Communication as depicted from clause 6.4.3.1 to clause 6.4.3.5 are same for the end-to-end connection between peer 5G ProSe End UEs.

6.4.3.7.4 Layer-2 Link Management Over PC5 Reference Point for 5G ProSe UE-to-UE Relay Communication with Integrated Discovery

This clause is for the 5G ProSe UE-to-UE Relay Communication with integrated Discovery procedure as described in clause 6.7.3.

The Direct Communication Request message over the first hop PC5 reference point includes:
User Info ID of source 5G ProSe End UE.
(optional) User Info ID of target 5G ProSe End UE: the identity of the target 5G ProSe End UE if provided from the ProSe application layer.
(optional) Destination Layer-2 ID of target 5G ProSe End UE: the unicast destination Layer-2 ID of the target 5G ProSe End UE determined by the source 5G ProSe End UE as specified in clause 5.8.2.4.
ProSe Service Info: the information about the ProSe identifier(s) requesting Layer-2 link establishment.
RSC: the connectivity service provided by the 5G ProSe UE-to-UE Relay as requested by the source 5G ProSe End UE.
Relay_indication: indicates whether the Direct Communication Request message can be forwarded by a 5G ProSe UE-to-UE Relay.
Security Information: the information for the establishment of security for the first hop PC5 link establishment.
NOTE 1: The Security Information is defined by SA WG3.

The Direct Communication Request message over the second hop PC5 reference point includes:
User Info ID of source 5G ProSe End UE.
User Info ID of 5G ProSe UE-to-UE Relay.
(optional) User Info ID of target 5G ProSe End UE.
ProSe Service Info: the information about the ProSe identifier(s).
RSC: the connectivity service provided by the 5G ProSe UE-to-UE Relay as requested by the source 5G ProSe End UE.
Security Information: the information for the establishment of security for the second hop PC5 link establishment.
NOTE 2: The Security Information is defined by SA WG3.

The Direct Communication Accept message over the second hop PC5 reference point includes:
User Info ID of target 5G ProSe End UE.

The Direct Communication Accept message over the first hop PC5 reference point includes:
User Info ID of target 5G ProSe End UE.
User Info ID of 5G ProSe UE-to-UE Relay.

For the 5G ProSe Communication via 5G ProSe Layer-3 UE-to-UE Relay, additional clarifications are as following:
In the Security Procedure of the second hop PC5 reference point, the 5G ProSe Layer-3 UE-to-UE Relay provides the IP Address Configuration or Link-Local IPV6 Address to the target 5G ProSe End UE.
The Direct Communication Accept message over the second hop PC5 reference point additionally includes IP Address Configuration or Link-Local IPV6 Address (if IP communication is used), Ethernet MAC address of target 5G ProSe End UE (if Ethernet communication is used). QoS Info is not included in the Security Procedure or Direct Communication Accept message of the second hop PC5 reference point.
In the Security Procedure of the first hop PC5 reference point, the source 5G ProSe End UE provides the IP Address Configuration, Link-Local IPV6 Address and QoS Info of the end-to-end QoS to the 5G ProSe Layer-3 UE-to-UE Relay.
The 5G ProSe Layer-3 UE-to-UE Relay provides the QoS info of the second hop QoS to the target 5G ProSe End UE using the Layer-2 link modification as described in the clause 6.4.3.4.
The 5G ProSe Layer-3 UE-to-UE Relay decides the QoS Info of the first hop QoS with considering the received second hop QoS from the target 5G ProSe End UE, the Direct Communication Accept message over the first hop PC5 reference point additionally includes IP Address Configuration or Link-Local IPV6 Address, QoS Info of the first hop Qos and may include IP address of the target 5G ProSe End UE (if IP communication is used) or Ethernet MAC address of target 5G ProSe End UE (if Ethernet communication is used).

For the 5G ProSe Communication via 5G ProSe Layer-2 UE-to-UE Relay, the message contents over PC5 reference point for unicast mode 5G ProSe Direct Communication as depicted from clause 6.4.3.1 to clause 6.4.3.5 are same for the end-to-end connection between peer 5G ProSe End UEs.

### 6.7.1 5G ProSe Communication Via 5G ProSe Layer-3 UE-to-UE Relay

### 6.7.1.1 Layer-2 Link Establishment for PC5 Communication Via 5G ProSe Layer-3 UE-to-UE Relay

FIG. 6.7.1.1-1 shows the procedure for Layer-2 link establishment via 5G ProSe Layer-3 UE-to-UE Relay.

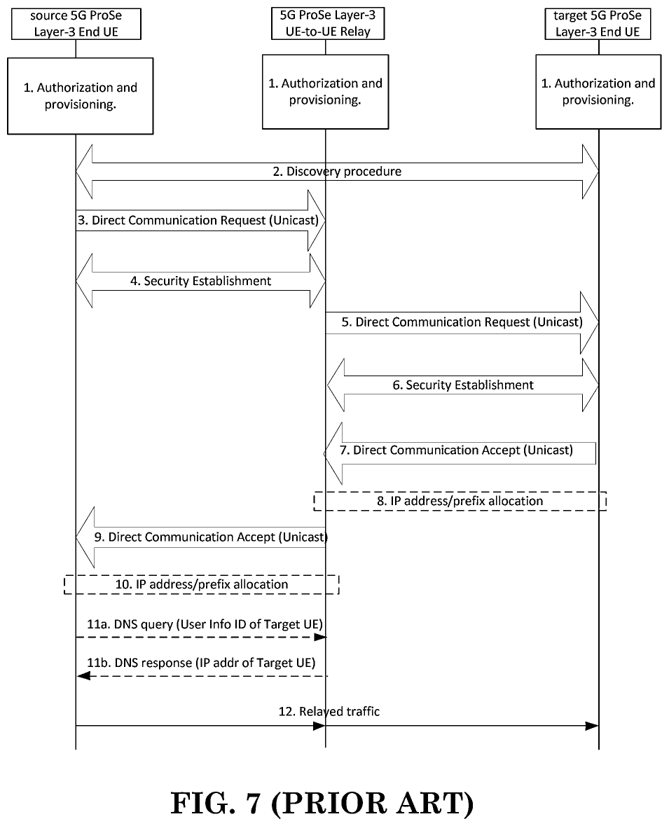

### [FIG. 6.7.1.1-1 of 3GPP TS 23.304 V18.2.0, Entitled “Layer-2 Link Establishment Via 5G ProSe Layer-3 UE-to-UE Relay”, is Reproduced as FIG. 7]

1. Service authorization and provisioning are performed for source 5G ProSe Layer-3 End UE, target 5G ProSe Layer-3 End UE and 5G ProSe Layer-3 UE-to-UE Relay as described in clause 6.2.
2. The source 5G ProSe Layer-3 End UE performs discovery of a 5G ProSe Layer-3 UE-to-UE Relay as described in clause 6.3.2.4.
3. The source 5G ProSe Layer-3 End UE sends a Direct Communication Request message to initiate the unicast Layer-2 link establishment procedure with the 5G ProSe Layer-3 UE-to-UE Relay. The parameters included in the Direct Communication Request message are described in clause 6.4.3.7.
   The Source Layer-2 ID of the Direct Communication Request message is self-assigned by the source 5G ProSe Layer-3 End UE, and the Destination Layer-2 ID is set to the Source Layer-2 ID of the discovery message of the 5G ProSe Layer-3 UE-to-UE Relay.
4. If the User Info ID of 5G ProSe Layer-3 UE-to-UE Relay in the Direct Communication Request message matches the 5G ProSe UE-to-UE Relay's User Info ID and the RSC in the Direct Communication Request matches one RSC that the relay supports, the 5G ProSe Layer-3 UE-to-UE Relay responds by establishing the security with the source 5G ProSe Layer-3 End UE. When the security protection is enabled, the source 5G ProSe Layer-3 End UE sends the parameters as described in clause 6.4.3.7 to the 5G ProSe Layer-3 UE-to-UE Relay.
   If the Ethernet MAC address of source 5G ProSe Layer-3 End UE is already used by another 5G ProSe Layer-3 End UE, then the 5G ProSe Layer-3 UE-to-UE Relay may send a message to the source 5G ProSe Layer-3 End UE indicating there is Ethernet MAC address conflict.
   The Source Layer-2 ID used for the security establishment procedure is self-assigned by the 5G ProSe Layer-3 UE-to-UE Relay, and the Destination Layer-2 ID is set to the Source Layer-2 ID of the received Direct Communication Request message.
   The 5G ProSe Layer-3 UE-to-UE Relay shall choose different Source Layer-2 IDs for PC5 links of different types of traffic, i.e., IP traffic, Ethernet traffic, and Unstructured traffic. If the PC5 link is used for transferring Unstructured traffic, the 5G ProSe Layer-3 UE-to-UE Relay shall choose different Source Layer-2 IDs for different pair of source and target 5G ProSe Layer-3 End UEs.
   Upon receiving the security establishment procedure messages, the source 5G ProSe Layer-3 End UE obtains the 5G ProSe Layer-3 UE-to-UE Relay's Layer-2 ID for future communication, for signalling and data traffic for this unicast link.
5. After the Security Establishment procedure in step 4 is completed, the 5G ProSe Layer-3 UE-to-UE Relay sends a Direct Communication Request message to initiate the unicast Layer-2 link establishment procedure with the target 5G ProSe Layer-3 End UE. The parameters included in the Direct Communication Request message are described in clause 6.4.3.7.
   The Source Layer-2 ID of the Direct Communication Request message is self-assigned by the 5G ProSe Layer-3 UE-to-UE Relay, and the Destination Layer-2 ID is the unicast Layer-2 ID of target 5G ProSe Layer-3 End UE associated with the User Info ID of target 5G ProSe Layer-3 End UE.
   The 5G ProSe Layer-3 UE-to-UE Relay shall choose different Source Layer-2 IDs for PC5 links of different types of traffic, i.e., IP traffic, Ethernet traffic, and Unstructured traffic. If the PC5 link is used for transferring Unstructured traffic, the 5G ProSe Layer-3 UE-to-UE Relay shall choose different Source Layer-2 IDs for different pair of source and target 5G ProSe Layer-3 End UEs.
6. If the User Info ID of target 5G ProSe Layer-3 End UE and RSC included in the Direct Communication Request match the target UE's User Info ID and the RSC that the target UE supports, the target 5G ProSe Layer-3 End UE responds by establishing the security with the 5G ProSe Layer-3 UE-to-UE Relay. When the security protection is enabled, the 5G ProSe Layer-3 UE-to-UE Relay sends the parameters as described in clause 6.4.3.7 to the target 5G ProSe Layer-3 End UE.
   The Source Layer-2 ID used for the security establishment procedure is self-assigned by the target 5G ProSe Layer-3 End UE, and the Destination Layer-2 ID is set to the Source Layer-2 ID of the received Direct Communication Request message.
   Upon receiving the security establishment procedure messages, the 5G ProSe Layer-3 UE-to-UE Relay obtains the target 5G ProSe Layer-3 End UE's Layer-2 ID for future communication, for signalling and data traffic for this unicast link.
7. The target 5G ProSe Layer-3 End UE sends a Direct Communication Accept message to the 5G ProSe Layer-3 UE-to-UE Relay that has successfully established security with. The parameters included in the Direct Communication Accept message are described in clause 6.4.3.7.
8. For IP traffic, IPV6 prefix or IPv4 address is allocated for the target 5G ProSe Layer-3 End UE as defined in clause 5.5.1.4.
9. After receiving the Direct Communication Accept message from the target 5G ProSe Layer-3 End UE, the 5G ProSe Layer-3 UE-to-UE Relay sends a Direct Communication Accept message to the source 5G ProSe Layer-3 End UE that has successfully established security with. The parameters included in the Direct Communication Accept message are described in clause 6.4.3.7.
10. For IP traffic, IPv6 prefix or IPv4 address is allocated for the source 5G ProSe Layer-3 End UE as defined in clause 5.5.1.4.
11. For IP communication, the 5G ProSe Layer-3 UE-to-UE Relay may store an association of User Info ID and the IP address of target 5G ProSe Layer-3 End UE into its DNS entries, and the 5G ProSe Layer-3 UE-to-UE Relay may act as a DNS server to other UEs. The source 5G ProSe Layer-3 End UE may send a DNS query to the 5G ProSe Layer-3 UE-to-UE Relay to request IP address of target 5G ProSe Layer-3 End UE after step 10 if the IP address of target 5G ProSe Layer-3 End UE is not received in step 9, and the 5G ProSe Layer-3 UE-to-UE Relay returns the IP address of the target 5G ProSe Layer-3 End UE to the source 5G ProSe Layer-3 End UE.
   For Ethernet communication, the 5G ProSe Layer-3 UE-to-UE Relay maintains the association between PC5 links and Ethernet MAC addresses received from the 5G ProSe Layer-3 End UE.
   For Unstructured traffic communication, for each pair of source and target 5G ProSe Layer-3 End UEs, the 5G ProSe Layer-3 UE-to-UE Relay maintains the 1:1 mapping between the PC5 link with source 5G ProSe Layer-3 End UE and the PC5 link with target 5G ProSe Layer-3 End UE.
12. The source 5G ProSe Layer-3 End UE communicates with the target 5G ProSe Layer-3 End UE via the 5G ProSe Layer-3 UE-to-UE Relay.

In the case of one source 5G ProSe Layer-3 End UE communicates with multiple target 5G ProSe Layer-3 End UEs, the PC5 link between the source 5G ProSe Layer-3 End UE and the 5G ProSe Layer-3 UE-to-UE Relay can be shared for multiple target 5G ProSe Layer-3 End UEs per RSC while the PC5 links may be established individually between the 5G ProSe Layer-3 UE-to-UE Relay and target 5G ProSe Layer-3 End UEs per RSC. For the shared PC5 link, the Layer-2 link modification procedure shall be used.

In the case of multiple source 5G ProSe Layer-3 End UEs communicate with one target 5G ProSe Layer-3 End UE, the PC5 link between the 5G ProSe Layer-3 UE-to-UE Relay and the target 5G ProSe Layer-3 End UE can be shared per RSC while the PC5 links may be established individually between the source 5G ProSe Layer-3 End UEs and the 5G ProSe Layer-3 UE-to-UE Relay per RSC. For the shared PC5 link, the Layer-2 link modification procedure shall be used.

3GPP R2-2307920 introduces NR sidelink relay enhancements to NR Stage 2 Specification (i.e. TS 38.300). Enhancements on UE-to-UE Relay are as follows:

### 16.12 Sidelink Relay

### 16.12.1 General

Sidelink relay is introduced to support 5G ProSe UE-to-Network Relay (U2N Relay) function (specified in TS 23.304 [48]) to provide connectivity to the network for U2N Remote UE(s). Both L2 and L3 U2N Relay architectures are supported. The L3 U2N Relay architecture is transparent to the serving NG-RAN of the U2N Relay UE, except for controlling sidelink resources. The detailed architecture and procedures for L3 U2N Relay can be found in TS 23.304 [48]. A U2N Relay UE shall be in RRC_CONNECTED to perform relaying of unicast data.

For L2 U2N Relay operation, the following RRC state combinations are supported:
Both L2 U2N Relay UE and L2 U2N Remote UE shall be in RRC_CONNECTED to perform transmission/reception of relayed unicast data; and
The L2 U2N Relay UE can be in RRC_IDLE, RRC_INACTIVE or RRC_CONNECTED as long as all the L2 U2N Remote UE(s) that are connected to the L2 U2N Relay UE are either in RRC_INACTIVE or in RRC_IDLE.

A single unicast link is established between one L2 U2N Relay UE and one L2 U2N Remote UE. The traffic to the NG-RAN of L2 U2N Remote UE via a given L2 U2N Relay UE and the traffic of the L2 U2N Relay UE shall be separated in different Uu RLC channels.

For L2 U2N Relay, the L2 U2N Remote UE can only be configured to use resource allocation mode 2 (as specified in 5.7.2 and 16.9.3.1) for data to be relayed.

A U2U Relay UE is to support UE-to-UE relay (U2U Relay) function as specified in TS 23.304 to provide coverage extension of the sidelink transmissions between two U2U Remote UEs. For the coverage extension, the U2U Remote UE can communicate with the peer U2U remote UE which could not have been reached within the sidelink coverage. The U2U Relay UE and U2U Remote UE can be in any RRC state. The U2U Relay UE and the U2U Remote UEs can be in the coverage of different cells. For U2U Relay, NR PC5 sidelink is supported between U2U Relay UE and U2U Remote UEs. Only unicast is supported between U2U Relay UE and U2U Remote UEs.

### 16.12.2.x L2 UE-to-UE Relay

The protocol stacks for the user plane and the control plane of the L2 U2U Relay architecture are illustrated in FIG. 16.12.2.x-1 and FIG. 16.12.2.x-2. The SRAP sublayer is placed above the RLC sublayer for both CP and UP at both PC5 interfaces. The sidelink SDAP, PDCP, and RRC are terminated between two L2 U2U Remote UEs, while SRAP, RLC, MAC, and PHY are terminated in each PC5 link wherein each link is between L2 U2U Remote UE and the L2 U2U Relay UE.

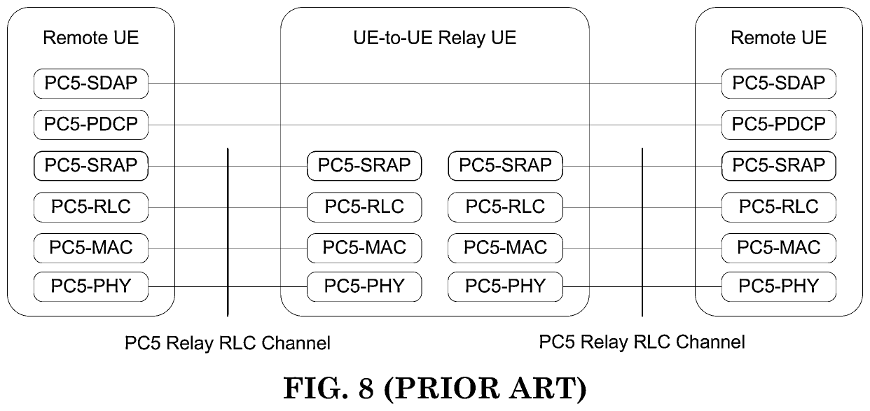

### [FIG. 16.12.2.x-1 of 3GPP R2-2307920, Entitled “User Plane Protocol Stack for L2 UE-to-UE Relay”, is Reproduced as FIG. 8]

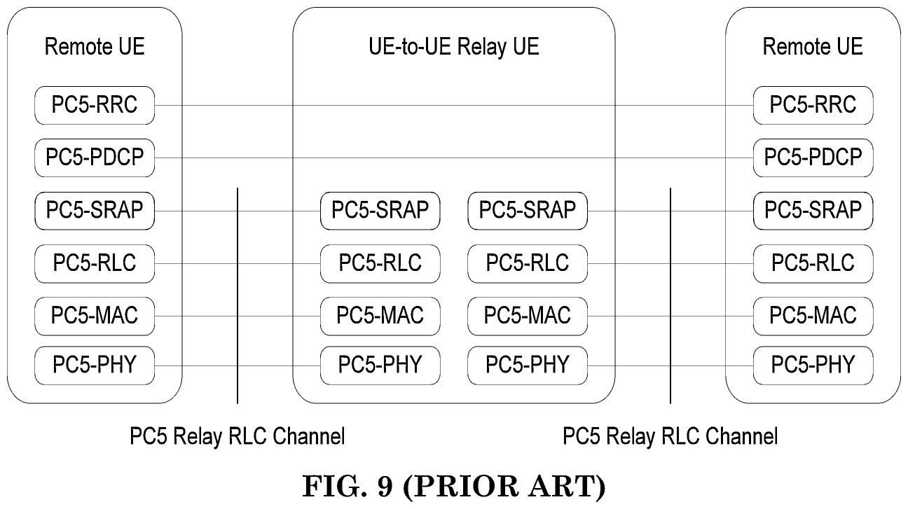

### [FIG. 16.12.2.x-2 of 3GPP R2-2307920, Entitled “Control Plane Protocol Stack for L2 UE-to-UE Relay”, is Reproduced as FIG. 9]

For L2 UE-to-UE Relay, the SRAP sublayer at L2 U2U Remote UE:
The SRAP sublayer at L2 U2U Remote UE performs bearer mapping between end-to-end SL Radio Bearers (SRB, DRB) of L2 U2U Remote UE and PC5 Relay RLC Channels over the L2 U2U Relay UE. When U2U Remote UE receives packets via the same egress PC5 Relay RLC channel for the different end-to-end bearers, the U2U Remote UE can identify the packets by using both the end-to-end bearer ID and the U2U Remote UE ID.
The PC5 SRAP sublayer at L2 U2U Remote UE supports identification of the peer L2 U2U Remote UE. An ID being able to be mapped to the peer L2 U2U Remote UE is included in the SRAP header of the traffic from the L2 U2U Remote UE to the L2 U2U Relay. An ID being able to be mapped to the L2 U2U Remote UE is included in the SRAP header of the traffic from L2 U2U Relay UE to the peer L2 U2U Remote UE.

For L2 UE-to-UE Relay, the SRAP sublayer at L2 U2U Relay UE:
The SRAP sublayer at L2 U2U Relay UE performs bearer mapping between ingress PC5 Relay RLC Channels and egress PC5 Relay RLC Channels by using both end-to-end bearer ID and U2U Remote UE ID.
The SRAP sublayer at L2 U2U Relay UE can perform data multiplexing from multiple ingress PC5 Relay RLC channels of the same/different L2 U2U Remote UEs to the same PC5 Relay RLC channel of the peer L2 U2U Remote UE for the different end-to-end bearers. The SRAP sublayer at L2 U2U Relay UE can perform data demultiplexing from the same ingress PC5 Relay RLC channel of the L2 U2U Remote UE to the multiple egress PC5 Relay RLC channel of the different peer L2 U2U Remote UEs for the different end-to-end bearers.
Editor's Notes: FFS on the details related to whether to use L2 ID/shorten ID or whether to include both or one ID in the SRAP header.

### 16.12.3 Relay Discovery

Model A and Model B discovery models as defined in TS 23.304 are supported for U2N Relay discovery. The protocol stack used for discovery is illustrated in FIG. 16.12.3-1.

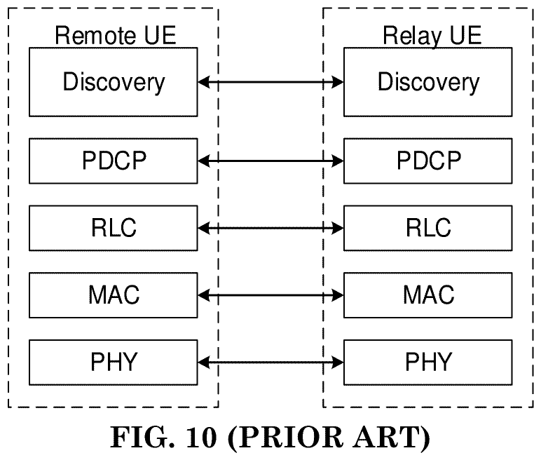

### [FIG. 16.12.3.1 of 3GPP R2-2307920, Entitled “Protocol Stack of Discovery Message for UE-to-Network/UE-to-UE Relay”, is Reproduced as FIG. 10]

The U2N Remote UE can perform Relay discovery message (i.e., as specified in TS 23.304 [48]) transmission and may monitor the sidelink for Relay discovery message while in RRC_IDLE, RRC_INACTIVE or RRC_CONNECTED. The network may broadcast or configure via dedicated RRC signalling a Uu RSRP threshold, which is used by the U2N Remote UE to determine if it can transmit Relay discovery messages to U2N Relay UE(s).

The U2N Relay UE can perform Relay discovery message (i.e., as specified in TS 23.304 [48]) transmission and may monitor the sidelink for Relay discovery message while in RRC_IDLE, RRC_INACTIVE or RRC_CONNECTED. The network may broadcast or configure via dedicated RRC signalling a maximum Uu RSRP threshold, a minimum Uu RSRP threshold, or both, which are used by the U2N Relay UE to determine if it can transmit Relay discovery messages to U2N Remote UE(s).

The U2U Remote UE and U2U Relay UE can perform Relay discovery message transmission and may monitor for Relay discovery message while in RRC_IDLE, RRC_INACTIVE, or RRC_CONNECTED. The network may provide the Relay discovery configuration using broadcast or dedicated signalling. In addition, the U2N Remote UE and L3 U2N Relay UE may use pre-configuration for Relay discovery.

The resource pool(s) used for NR sidelink communication can be used for Relay discovery or the network may configure resource pool(s) dedicated for Relay discovery. Resource pool(s) dedicated for Relay discovery can be configured simultaneously with resource pool(s) for NR sidelink communication in system information, dedicated signalling and/or pre-configuration. Whether dedicated resource pool(s) for Relay discovery are configured is based on network implementation. If resource pool(s) dedicated for Relay discovery are configured, only those resource pool(s) dedicated for Relay discovery shall be used for Relay discovery. If only resource pool(s) for NR sidelink communication are configured, all the configured resource pool(s) can be used for Relay discovery and NR sidelink communication.

For U2N Remote UE (including both in-coverage and out of coverage cases) that has been connected to the network via a U2N Relay UE, only resource allocation mode 2 is used for Relay discovery message transmission.

For in-coverage U2N Relay UE, and for both in-coverage and out of coverage U2N Remote UEs, NR sidelink resource allocation principles are applied for Relay discovery message transmission. For both in-coverage and out-of-coverage U2U Remote UEs, or U2U Relay UE, NR sidelink resource allocation principles, both mode-1 and mode-2, are applied for Relay discovery message transmission.

The sidelink power control for the transmission of Relay discovery messages is same as for NR sidelink communication.

No ciphering or integrity protection in PDCP layer is applied for the Relay discovery messages. The U2N/U2U Remote UE and U2N/U2U Relay UE can determine from SIB12 whether the gNB supports Relay discovery, or Non-Relay discovery, or both.
Editor's Notes: The detailed description for forwarding discovery messages based on PC5 RSRP threshold depending on the discovery model (model A/B, integrated-discovery) will be added after further discussion.

### 16.12.4 Relay Selection/Reselection

The U2N Remote UE performs radio measurements at PC5 interface and uses them for U2N Relay selection and reselection along with higher layer criteria, as specified in TS 23.304 [48]. When there is no unicast PC5 connection between the U2N Relay UE and the U2N Remote UE, the U2N Remote UE uses SD-RSRP measurements to evaluate whether PC5 link quality towards a U2N Relay UE satisfies relay selection criterion.

For relay reselection, U2N Remote UE uses SL-RSRP measurements towards the serving U2N Relay UE for relay reselection trigger evaluation when there is data transmission from U2N Relay UE to U2N Remote UE, and it is left to UE implementation whether to use SL-RSRP or SD-RSRP for relay reselection trigger evaluation in case of no data transmission from U2N Relay UE to U2N Remote UE.

A U2N Relay UE is considered suitable by a U2N Remote UE in terms of radio criteria if the PC5 link quality measured by U2N Remote UE towards the U2N Relay UE exceeds configured threshold (pre-configured or provided by gNB). The U2N Remote UE searches for suitable U2N Relay UE candidates that meet all AS layer and higher layer criteria (see TS 23.304 [48]). If there are multiple such suitable U2N Relay UEs, it is up to U2N Remote UE implementation to choose one U2N Relay UE among them. For L2 U2N Relay (re) selection, the PLMN ID and cell ID can be used as additional AS criteria.

The U2N Remote UE triggers U2N Relay selection in following cases:
Direct Uu signal strength of current serving cell of the U2N Remote UE is below a configured signal strength threshold;
Indicated by upper layer of the U2N Remote UE.

The U2N Remote UE may trigger U2N Relay reselection in following cases:
PC5 signal strength of current U2N Relay UE is below a (pre) configured signal strength threshold;
Cell reselection, handover, Uu RLF, or Uu RRC connection establishment/resume failure has been indicated by U2N Relay UE via PC5-RRC signalling;
When U2N Remote UE receives a PC5-S link release message from U2N Relay UE;
When U2N Remote UE detects PC5 RLF;
Indicated by upper layer.

For L2 U2N Remote UEs in RRC_IDLE or RRC_INACTIVE and L3 U2N Remote UEs, the cell (re) selection procedure and relay (re) selection procedure run independently. If both suitable cells and suitable U2N Relay UEs are available, it is up to the U2N Remote UE implementation to select either a cell or a U2N Relay UE. A L3 U2N Remote UE may select a cell and a L3 U2N Relay UE simultaneously and this is up to implementation of L3 U2N Remote UE.

For both L2 and L3 U2N Relay UEs in RRC_IDLE or RRC_INACTIVE, the PC5-RRC message(s) are used to inform their connected U2N Remote UE(s) when U2N Relay UEs select a new cell. The PC5-RRC message(s) are also used to inform their connected L2 or L3 U2N Remote UE(s) when L2 or L3 U2N Relay UE performs handover, detects Uu RLF, or its Uu RRC connection establishment/resume fails. Upon reception of the PC5 RRC message for notification, it is up to U2N Remote UE implementation whether to release or keep the unicast PC5 link. If U2N Remote UE decides to release the unicast PC5 link, it triggers the PC5 release procedure and may perform cell or relay reselection.

The U2U Remote UE performs radio measurements (i.e., SD-RSRP and/or SL-RSRP) at PC5 interface and uses them for U2U Relay selection and reselection along with higher layer criteria, as specified in TS 23.304 [48].

For relay selection, U2U Remote UE uses SL-RSRP measurements towards the peer U2U Remote UE for relay selection trigger evaluation when there is data transmission from U2U Remote UE to the peer U2U Remote UE. For the relay reselection, U2U Remote UE uses SL-RSRP measurement towards the U2U Relay UE for relay reselection trigger evaluation when there is data transmission from U2U Remote UE to U2U relay UE. It is left to U2U Remote UE implementation whether to use SL-RSRP or SD-RSRP for relay selection or reselection trigger evaluation in case of no data transmission from the U2U Remote UE to the peer U2U Remote UE or U2U Relay UE. The thresholds for SD-RSRP and SL-RSRP are configured separately for the trigger of U2U relay selection or reselection.

A U2U Relay UE is considered suitable by a U2U Remote UE in terms of radio criteria if the PC5 link quality measured by the U2U Remote UE towards the U2U Relay UE exceeds a configured threshold.

The U2U Remote UE triggers U2U Relay selection in the following cases:
The PC5 signal strength between U2U Remote UEs is below a (pre) configured signal strength threshold;
Indicated by the upper layer of the U2U Remote UE.

The U2U Remote UE triggers U2U Relay reselection in the following cases:
The PC5 signal strength of the current U2U Relay UE is below a (pre) configured signal strength threshold;
When U2U Remote UE detects PC5 RLF;
When U2U Remote UE receives the PC5 RLF indication from the U2U Relay UE;
When U2U Remote UE receives a PC5-S link release message from U2U Relay UE;
Indicated by the upper layer of the U2U Remote UE.

The relay selection/reselection can be triggered by each U2U Remote UE based on the current hop quality.

For the discovery model A, the U2U Relay UE should only announce the neighbour U2U Remote UE(s) for which the SD-RSRP/SL-RSRP between the U2U Relay and the neighbour U2U Remote UE is above a configured threshold in a discovery announce message. Upon discovery message reception, U2U Remote UE considers a U2U Relay UE as a candidate U2U Relay UE if the SD-RSRP towards the U2U Relay UE is above a configured threshold and satisfied with the upper layer criteria.

For the discovery model B, upon discovery response message reception, the U2U remote UE considers a U2U Relay UE as a candidate U2U Relay UE if the SD-RSRP towards the U2U Relay UE is above a configured threshold and satisfied with the upper layer criteria.

For the integrated-discovery, when receiving DCR message from one or multiple U2U Relay UEs, the U2U Remote UE should consider candidate U2U Relay UEs towards which the SL-RSRP is above a configured threshold to respond and that satisfy upper-layer criteria, and select a U2U Relay UE from among them.

3GPP R2-2309185 introduces NR sidelink UE-to-UE relay to NR Stage 3 Specification (i.e. TS 38.331). The procedure of notification message is as follows:

### 5.8.9.10 Notification Message

### 5.8.9.10.1 General

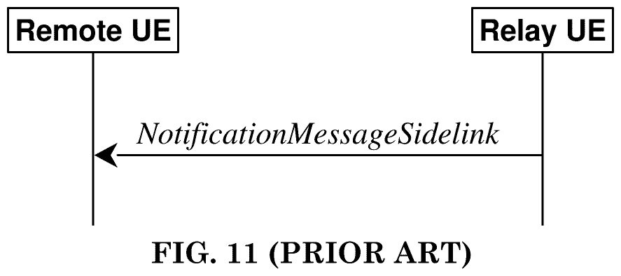

### [FIG. 5.8.9.8.1-1 of 3GPP R2-2309185, Entitled “Notification Message in Sidelink”, is Reproduced as FIG. 11]

This procedure is used by a U2N Relay UE to send notification to the connected U2N Remote UE. This procedure is also used by a U2U Relay UE to send notification to the connected U2U Remote UE.

### 5.8.9.10.2 Initiation

The Relay UE may initiate the procedure when one of the following conditions is met:
1> If the UE is acting as U2N Relay UE:
   2> upon Uu RLF as specified in 5.3.10;
   2> upon reception of an RRCReconfiguration including the reconfigurationWithSync;
   2> upon cell reselection;
   2> upon L2 U2N Relay UE's RRC connection failure including RRC connection reject as specified in 5.3.3.5 and 5.3.13.10, and T300 expiry as specified in 5.3.3.7, and RRC resume failure as specified in 5.3.13.5;
1> If the UE is acting as U2U Relay UE:
   2> upon detection of PC5 RLF with U2U Remote UE as specified in 5.8.9.3;
Editor Note: FFS the remote UE in previous agreement “When the remote UE receives PC5-RLF indication from the U2U relay UE, it would inform upper layers and rely on upper layers to trigger relay reselection (or not).” applies to both source and target remote UEs or not, applies to both L2 and L3 U2U relay or not.

### 5.8.9.10.3 Actions Related to Transmission of NotificationMessageSidelink Message

The Relay UE shall set the indication type as follows:
1> If the UE is acting as U2N Relay UE;
   2> if the UE initiates transmission of the NotificationMessageSidelink message due to Uu RLF:
      3> set the indicationType as relayUE-Uu-RLF;
   2> else if the UE initiates transmission of the NotificationMessageSidelink message due to reconfiguration with sync:
      3> set the indicationType as relayUE-HO;
   2> else if the UE initiates transmission of the NotificationMessageSidelink message due to cell reselection:
      3> set the indicationType as relayUE-CellReselection;
   2> if the UE initiates transmission of the NotificationMessageSidelink message due to Uu RRC connection establishment/Resume failure:
      3> set the indicationType as relayUE-Uu-RRC-Failure;
   2> submit the NotificationMessageSidelink message to lower layers for transmission;
1> If the UE is acting as U2U Relay UE:
   2> if the UE initiates transmission of the NotificationMessageSidelink message due to PC5 RLF:
      3> set the sl-IndicationType as relayUE-PC5-RLF.

### 5.8.9.10.4 Actions Related to Reception of NotificationMessageSidelink Message

Upon receiving the NotificationMessageSidelink, the Remote UE shall:
1> if the UE is acting as U2N Remote UE:
   2> if the indicationType is included:
      3> if the UE is L2 U2N Remote UE in RRC_CONNECTED:
         4> if T301 is not running, initiate the RRC connection re-establishment procedure as specified in 5.3.7;
      3> else (the UE is L3 U2N Remote UE, or L2 U2N Remote UE in RRC_IDLE or RRC_INACTIVE):
         4> if the PC5-RRC connection with the U2N Relay UE is determined to be released:
         5> indicate upper layers to trigger PC5 unicast link release;
         4> else (i.e., maintain the PC5 RRC connection):
         5> if the UE is L2 U2N Remote UE and the indicationType is relayUE-HO or relayUE-CellReselection:
         6> consider cell re-selection occurs;
NOTE 1: For L3 U2N Remote UE, or L2 U2N Remote UE in RRC_IDLE or RRC_INACTIVE, it is up to Remote UE implementation whether to release or keep the PC5 unicast link.
NOTE 2: The L2 U2N Remote UE may ignore the NotificationMessageSidelink if it does not release the PC5 unicast link in source side yet during an indirect-to-direct path switch, i.e. T304 is running.
1> if the UE is acting as U2U Remote UE:
   2> if sl-IndicationType is relayUE-PC5-RLF:
      3> indicate upper layers to trigger reselection of NR sidelink U2U Relay UE; Editor Note: FFS if there would be any constraints on the Remote UE implementation behaviour to keep or release the PC5 link with the relay UE.

### NotificationMessageSidelink

The NotificationMessageSidelink message is used to send notification message from U2N Relay UE to the connected U2N Remote UE or from U2U Relay UE to the connected U2U Remote.
Signalling radio bearer: SL-SRB3
RLC-SAP: AM
Logical channel: SCCH
Direction: U2N Relay UE to U2N Remote UE or U2U Relay UE to U2U Remote UE

### NotificationMessageSidelink Message

-- ASN1START
-- TAG-NOTIFICATIONMESSAGESIDELINK-START

| | |
|---|---|
| NotificationMessageSidelink-r17 ::= | SEQUENCE { |
| criticalExtensions | CHOICE { |
| notificationMessageSidelink-r17 | NotificationMessageSidelink-r17-IEs, |
| criticalExtensionsFuture | SEQUENCE { } |

}
}

| | |
|---|---|
| NotificationMessageSidelink-r17-IEs ::= | SEQUENCE { |
| indicationType-r17 | ENUMERATED { |
| | relayUE-Uu-RLF, relayUE-HO, relayUE- |

CellReselection,

```
        relayUE-Uu-RRC-Failure
    }
```

OPTIONAL, -- Need N

| | |
|---|---|
| lateNonCriticalExtension | OCTET STRING |

OPTIONAL,
nonCriticalExtension NotificationMessageSidelink-v18xy-IEs ::=
OPTIONAL
}

| | |
|---|---|
| NotificationMessageSidelink-v18xy-IEs ::= | SEQUENCE { |
| sl-IndicationType-r18 | ENUMERATED {relayUE-PC5-RLF. FFS} |

OPTIONAL, -- Need N

| | |
|---|---|
| nonCriticalExtension | SEQUENCE { } |

OPTIONAL
}
-- TAG-NOTIFICATIONMESSAGESIDELINK -STOP
-- ASN1STOP

3GPP TS 23.304 introduces UE-to-UE (U2U) Relay in Release 18. For single hop UE-to-UE Relay, a UE-to-UE relay may be used to support data communication between two remote UEs in case these two remote UEs cannot communicate with each other directly. A UE-to-UE relay needs to establish one PC5 unicast link (or PC5 RRC connection) with each of a source remote UE and a target remote UE. In case of Layer-2 UE-to-UE Relay, an end-to-end link (or connection) for unicast communication may be established between these two remote UEs after the previous two PC5 unicast links have been established between the UE-to-UE relay and two remote UEs.

After being connected to a U2U relay UE for communicating with each other via the U2U relay UE, remote UEs may keep performing the measurement of the signal strengths of the PC5 unicast links with the U2U relay UE for relay reselection. In addition, the U2U relay UE may also keep performing the measurement of the signal strengths of the PC5 unicast links with the remote UEs. As captured in R2-2309185, when the U2U relay UE detects PC5 (or sidelink) radio link failure (RLF) with one remote UE, it may send a notification message (i.e. NotificationMessageSidelink) to the peer remote UE so that the peer remote UE can indicate upper layers to trigger relay reselection. The notification message includes a sl-Indication Type indicating relayUE-PC5-RLF. Since one remote UE may connect or communicate with multiple remote UEs via one U2U relay UE according to 3GPP TS 23.304, there is a need for the U2U relay UE to include information in the notification message for identifying the remote UE with which the PC5 RLF is detected so that the upper layers of the peer remote UE can perform relay reselection for the identified remote UE. The information for identifying the remote UE may be a layer-2 ID, an application layer ID or a user info ID of the remote UE. Alternatively, the information for identifying the remote UE may be a local/short ID used in the SRAP header to identify the remote UE or a pair ID used in the SRAP header to identify the pair of the remote UE and the peer remote UE.

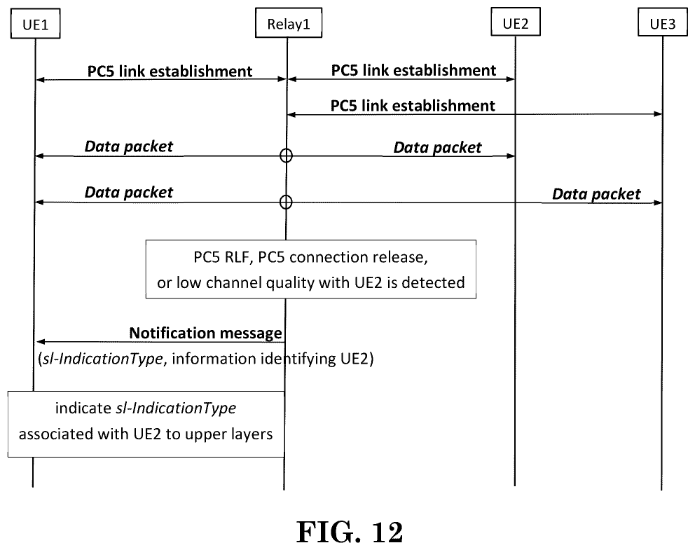

It is also beneficial for the U2U relay UE to send a notification message to the peer remote UE, when the PC5 unicast link (or PC5 RRC connection) with one remote UE is released, so that the peer remote UE can indicate the sl-IndicationType to upper layers so as to trigger relay reselection. In this situation, the notification message may include a sl-IndicationType indicating relayUE-PC5-release and information identifying the remote UE with which the PC5 unicast link (or PC5 RRC connection) is released. FIG. 12 illustrates an example of notification message transmission for single hop U2U Relay.

It is also beneficial for the U2U relay UE to send a notification message to the peer remote UE, when channel quality on the PC5 unicast link (or PC5 RRC connection) with one remote UE is below a threshold, so that the peer remote UE can indicate the sl-IndicationType to upper layers so as to trigger relay reselection. In this situation, the notification message may include a sl-IndicationType indicating e.g. bad channel quality and information identifying the remote UE with which the PC5 unicast link's (or PC5 RRC connection's) channel quality is below a threshold.

For example, in FIG. 12, UE1 (i.e. source end UE or first remote UE) may communicate with UE2 and UE3 (i.e. target end UEs or second remote UEs) via a single relay UE (i.e. Relay 1). In response to detection of PC5 RLF, PC5 connection release or bad channel quality on UE2, Relay 1 may send a notification message to UE1. In the notification message, a layer-2 ID, an application layer ID or an user info ID of UE2 may be included in addition to a sl-IndicationType. Alternatively, a local/short ID used to identify UE2 in SRAP header could be included in the notification message. Alternatively, a pair ID used to identify a pair of UE1 and UE2 in SRAP header could be included in the notification message.

It is also feasible that the notification message may include the information identifying the concerned remote UE and may not include any SL indication type, since no matter which reason of the SL indication type the peer remote UE could perform relay reselection in response to reception of the notification message. In other words, the notification message including the information identifying the concerned remote UE (but not including the SL indication type) could imply PC5 RLF detection, RC5 connection release or bad channel quality on the concerned remote UE.

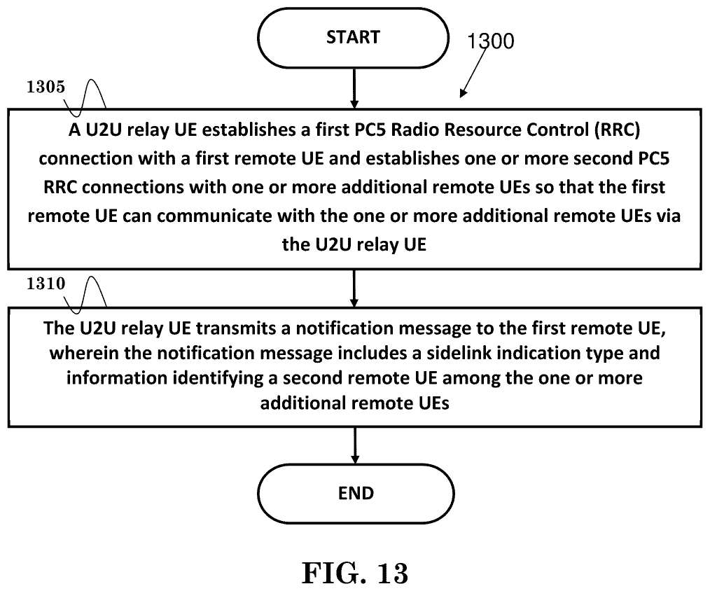

FIG. 13 is a flow chart 1300 for notification message transition. In step 1305, a UE-to-UE (U2U) relay UE establishes a first PC5 Radio Resource Control (RRC) connection with a first remote UE and establishes one or more second PC5 RRC connections with one or more additional remote UEs so that the first remote UE can communicate with the one or more additional remote UEs via the U2U relay UE. In step 1310, the U2U relay UE transmits a notification message to the first remote UE, wherein the notification message includes a sidelink indication type and information identifying a second remote UE among the one or more additional remote UEs.

In one embodiment, each PC5 RRC connection of the first PC5 RRC connection and the multiple second PC5 RRC connections may be a Layer-2 link over PC5 reference point. The sidelink indication type may be a PC5 radio link failure (RLF) with the second remote UE. The notification message could be transmitted when the PC5 RLF with the second remote UE is detected by the U2U relay UE.

In one embodiment, the sidelink indication type may be a PC5 RRC connection release with the second remote UE. The notification message could be transmitted when a PC5 RRC connection between the U2U relay UE and the second remote UE is released.

Referring back to FIGS. 3 and 4, in one exemplary embodiment from the perspective of a UE-to-UE (U2U) relay UE. The U2U relay UE 300 includes a program code 312 stored in the memory 310. The CPU 308 could execute program code 312 to enable the U2U relay UE (i) to establish a first PC5 Radio Resource Control (RRC) connection with a first remote UE and establishes one or more second PC5 RRC connections with one or more additional remote UEs so that the first remote UE can communicate with the one or more additional remote UEs via the U2U relay UE, and (ii) to transmit a notification message to the first remote UE, wherein the notification message includes a sidelink indication type and information identifying a second remote UE among the one or more additional remote UEs. Furthermore, the CPU 308 can execute the program code 312 to perform all of the above-described actions and steps or others described herein.

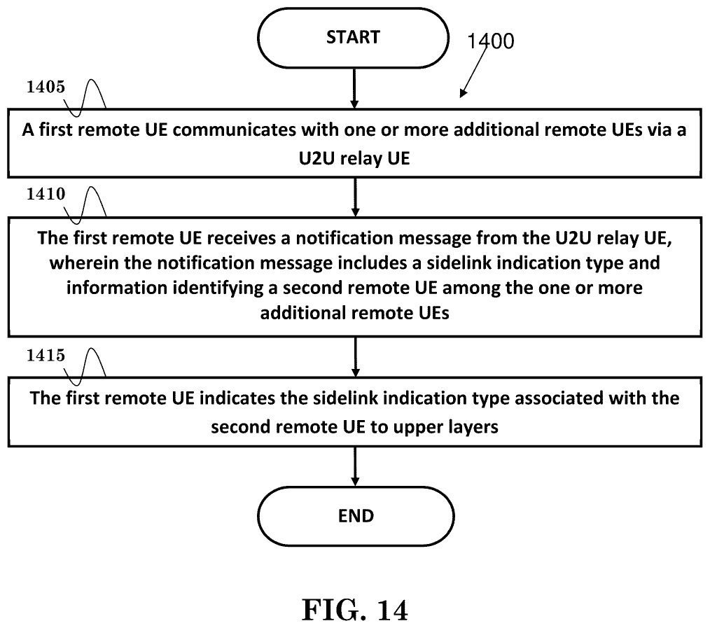

FIG. 14 is a flow chart 1400 for notification message transition. In step 1405, a first remote UE communicates with one or more additional remote UEs via a UE-to-UE (U2U) relay UE. In step 1410, the first remote UE receives a notification message from the U2U relay UE, wherein the notification message includes a sidelink indication type and information identifying a second remote UE among the one or more additional remote UEs. In step 1415, the first remote UE indicates the sidelink indication type associated with the second remote UE to upper layers.

In one embodiment, a first PC5 RRC connection may be established between the first remote UE and the U2U relay UE and one or more second PC5 RRC connections are established between the U2U relay UE and the one or more additional remote UEs. The sidelink indication type may be a PC5 radio link failure (RLF) with the second remote UE. The notification message may be received after the PC5 RLF with the second remote UE is detected by the U2U relay UE.

In one embodiment, the sidelink indication type may be a PC5 RRC connection release with the second remote UE. The notification message may be received after a PC5 RRC connection between the U2U relay UE and the second remote UE is released.

Referring back to FIGS. 3 and 4, in one exemplary embodiment from the perspective of a first remote UE. The first remote UE 300 includes a program code 312 stored in the memory 310. The CPU 308 could execute program code 312 to enable the first remote UE (i) to communicate with one or more additional remote UEs via a U2U relay UE, (ii) to receive a notification message from the U2U relay UE, wherein the notification message includes a sidelink indication type and information identifying a second remote UE among the one or more additional remote UEs, and (iii) to indicate the sidelink indication type associated with the second remote UE to upper layers. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for notification message transmission, comprising:
a UE-to-UE (U2U) relay UE establishes a first PC5 Radio Resource Control (RRC) connection with a first remote UE and establishes one or more second PC5 RRC connections with one or more additional remote UEs so that the first remote UE can communicate with the one or more additional remote UEs via the U2U relay UE; and
the U2U relay UE transmits a notification message to the first remote UE after the first PC5 RRC connection between the U2U relay UE and the first remote UE has been established, wherein the notification message includes a sidelink indication type and information identifying a second remote UE among the one or more additional remote UEs.

2. The method of claim 1, wherein each PC5 RRC connection of the first PC5 RRC connection and the one or more second PC5 RRC connections is a Layer-2 link over PC5 reference point.

3. The method of claim 1, wherein the sidelink indication type is a PC5 radio link failure (RLF) with the second remote UE.

4. The method of claim 3, wherein the notification message is transmitted when the PC5 RLF with the second remote UE is detected by the U2U relay UE.

5. The method of claim 1, wherein the sidelink indication type is a PC5 RRC connection release with the second remote UE.

6. The method of claim 5, wherein the notification message is transmitted when a PC5 RRC connection between the U2U relay UE and the second remote UE is released.

7. A UE-to-UE (U2U) relay UE, comprising:
a control circuit;
a processor installed in the control circuit; and
a memory installed in the control circuit and operatively coupled to the processor;
wherein the processor is configured to execute a program code stored in the memory to:
establish a first PC5 Radio Resource Control (RRC) connection with a first remote UE and establishes one or more second PC5 RRC connections with one or more additional remote UEs so that the first remote UE can communicate with the one or more additional remote UEs via the U2U relay UE; and
transmit a notification message to the first remote UE after the first PC5 RRC connection between the U2U relay UE and the first remote UE has been established, wherein the notification message includes a sidelink indication type and information identifying a second remote UE among the one or more additional remote UEs.

8. The U2U relay UE of claim 7, wherein each PC5 RRC connection of the first PC5 RRC connection and the one or more second PC5 RRC connections is a Layer-2 link over PC5 reference point.

9. The U2U relay UE of claim 7, wherein the sidelink indication type is a PC5 radio link failure (RLF) with the second remote UE.

10. The U2U relay UE of claim 9, wherein the notification message is transmitted when the PC5 RLF with the second remote UE is detected by the U2U relay UE.

11. The U2U relay UE of claim 7, wherein the sidelink indication type is a PC5 RRC connection release with the second remote UE.

12. The U2U relay UE of claim 11, wherein the notification message is transmitted when a PC5 RRC connection between the U2U relay UE and the second remote UE is released.

13. A method for notification message reception, comprising:
a first remote UE communicates with one or more additional remote UEs via a UE-to-UE (U2U) relay UE;
the first remote UE receives a notification message from the U2U relay UE after a first PC5 RRC connection between the first remote UE and the U2U relay UE has been established, wherein the notification message includes a sidelink indication type and information identifying a second remote UE among the one or more additional remote UEs; and
the first remote UE indicates the sidelink indication type associated with the second remote UE to upper layers.

14. The method of claim 13, wherein and one or more second PC5 RRC connections are established between the U2U relay UE and the one or more additional remote UEs.

15. The method of claim 13, wherein the sidelink indication type is a PC5 radio link failure (RLF) with the second remote UE.

16. The method of claim 15, wherein the notification message is received after the PC5 RLF with the second remote UE is detected by the U2U relay UE.

17. The method of claim 13, wherein the sidelink indication type is a PC5 RRC connection release with the second remote UE.

18. The method of claim 17, wherein the notification message is received after a PC5 RRC connection between the U2U relay UE and the second remote UE is released.
